(19) United States
(12) Patent Application Publication
(10) Pub. No.: US 2026/0018947 A1
(43) Pub. Date: Jan. 15, 2026

(54) Rotor With Winding Supports and Positively Connected Support Device

(71) Applicant: Bayerische Motoren Werke Aktiengesellschaft, Muenchen (DE)

(72) Inventor: Herbert HOLZER, Eching (DE)

(21) Appl. No.: 19/267,768

(22) Filed: Jul. 14, 2025

(30) Foreign Application Priority Data
Jul. 15, 2024 (DE) 10 2024 120 022.7

(51) Int. Cl. H02K 1/24; H02K 3/18

(52) U.S. Cl. CPC H02K 1/24; H02K 3/18

(57) ABSTRACT

The invention relates to a rotor for an externally excited electric machine of a motor vehicle, having: a rotor body with a large number of salient poles, wherein in each case one groove extending axially between two end sides of the rotor body is formed between two adjacent salient poles; rotor windings including winding conductors that are wound about the salient poles forming axial and end-side winding portions, wherein the axial winding portions of two adjacent rotor windings are arranged in each groove and the end-side winding portions form protruding winding heads at the end sides of the rotor body; per groove, one winding support is arranged between the axial winding portions of the two adjacent rotor windings; and two support devices, arranged at the end sides of the rotor body for covering the winding heads.

### CROSS REFERENCE TO RELATED APPLICATION

This application claims priority under 35 U.S.C. § 119 from German Patent Application No. 10 2024 120 022.7, filed Jul. 15, 2024, the entire disclosure of which is herein expressly incorporated by reference.

### BACKGROUND AND SUMMARY

The invention relates to a rotor for an externally excited electric machine of a motor vehicle. The rotor comprises a rotor body with a large number of salient poles, wherein in each case one groove extending axially between two end sides of the rotor body is formed between two adjacent salient poles. The rotor moreover comprises rotor windings for exciting a rotor magnetic field, the winding conductors of which are wound about the salient poles with the formation of axial and end-side winding portions, wherein the axial winding portions of two adjacent rotor windings are arranged in each groove and the end-side winding portions form protruding winding heads at the end sides of the rotor body. In addition, the rotor comprises, per groove, one winding support for supporting the rotor windings which is arranged between the axial winding portions of the two adjacent rotor windings and is designed to push the axial winding portions against the associated salient pole. The rotor moreover comprises two support devices, arranged at the end sides of the rotor body and fastened on the rotor body via an axial force, for covering the winding heads. The invention moreover relates to an electric machine for a motor vehicle.

In the present case, the focus is on externally excited or current-excited electric machines for electrified motor vehicles, for example electric or hybrid vehicles. Such machines usually have a stationary stator and a rotor mounted rotatably with respect to the stator. The rotor has energizable rotor windings which are held by a rotor body, for example a rotor lamination stack. In the case of a rotor body with a salient-pole design, winding conductors of the rotor windings are wound about the salient poles and as a result arranged in portions in axial grooves of the rotor body. It is known here from the prior art to pot the rotor with a potting compound in order to mechanically support the rotor windings against centrifugal forces when the rotor rotates. The potting of the rotor is technically complex and entails high costs. It results in a high risk of rejection in the production process and in a high degree of complexity of individual components, for example, because it is ensured that specific cavities situated in the rotor which are intended to remain free of potting compound are sealed accordingly.

It is therefore known from the prior art, for example DE 10 2022 130 317 A1, to equip the rotor with winding supports which are arranged in the grooves between winding portions of two adjacent rotor windings and thus push the winding portions against the salient poles. For this purpose, the winding supports can be designed, for example, as flat springs with a V-shaped cross section. The rotor moreover has an end-side winding support with a large number of groove elements which is designed to act on end faces of the corresponding large number of winding supports arranged in the rotor grooves in order to fix said winding supports in the axial direction. A support ring of the rotor can fasten the large number of winding supports arranged in the rotor grooves and the end-side winding support on the rotor in the radial direction. By virtue of such a configuration of the rotor, the rotor can be formed without any potting.

An object of the present invention is to supply an alternative solution to the prior art for fixing rotor windings of a rotor of an electric machine.

This object is achieved according to forms of the invention by a rotor and an electric machine having the features according to the respective independent claims. Advantageous embodiments of the invention are the subject of the dependent claims, the description, and the Figures.

A rotor according to forms of the invention for an externally excited electric machine of a motor vehicle comprises a rotor body with a large number of salient poles, wherein in each case one groove extending axially between two end sides of the rotor body is formed between two adjacent salient poles. The rotor moreover comprises rotor windings for exciting a rotor magnetic field, the winding conductors of which are wound about the salient poles with the formation of axial and end-side winding portions, wherein the axial winding portions of two adjacent rotor windings are arranged in each groove and the end-side winding portions form protruding winding heads at the end sides of the rotor body. In addition, the rotor has, per groove, one winding support for supporting the rotor windings which is arranged between the axial winding portions of the two adjacent rotor windings and is designed to push the axial winding portions against the associated salient pole. The rotor also has two support devices, arranged at the end sides of the rotor body and fastened on the rotor body via an axial force, for covering the winding heads. A support ring, radially surrounding the winding head, of the respective support device has a wedge-shaped cross section at least in some regions, and end portions, projecting axially on both sides from the grooves, of the winding supports have in each case at least in some regions a wedge-shaped cross section which forms, with the wedge-shaped cross section of the respective support ring, a positive conical connection, pushing the winding supports into the grooves via a radial force, between the winding supports and the support devices.

The invention moreover relates to an externally excited electric machine for a motor vehicle with a stator and a rotor according to the invention which is mounted rotatably with respect to the stator. The electric machine is in particular a drive machine or traction machine for a motor vehicle in the form of an electrified motor vehicle. The electric machine can be, for example, a current-excited synchronous machine. The electric machine is preferably an internal rotor machine in which the stator surrounds the rotor and the rotor is mounted rotatably inside a hollow cylindrical stator body of the stator.

The rotor has the rotor body which is designed in particular as a lamination stack of axially stacked electrical sheet-metal laminations. The rotor body is manufactured with a salient pole design and has an annular rotor yoke through which a rotor shaft passes. The rotor shaft is connected non-rotatably to the rotor body. Arranged distributed on the circumference of the rotor yoke are the salient poles which in each case have a pole tooth which protrudes radially from the rotor yoke and in particular has parallel flanks, and a pole shoe radially adjoining the pole tooth. A groove which extends axially through the rotor body is formed between two adjacent pole teeth. Formed between two adjacent pole shoes is a pole gap, the tangential width of which is smaller than a tangential width of the respective groove and which forms an access opening to the respective groove.

The salient poles carry in each case a rotor winding or rotor coil. To form the latter, a winding conductor, in particular a wire, is wound about the pole tooth of the respective salient pole. The pole shoes support the rotor windings in the radial direction and prevent the rotor windings from slipping off the pole teeth because of the centrifugal force. Each rotor winding has in each case two axial groove-internal winding portions which bear against tooth flanks of the associated pole tooth. One axial winding portion of a first rotor winding and one axial winding portion of a second rotor winding wound about the adjacent pole tooth are arranged here per groove. Each rotor winding moreover has two end-side winding portions which are arranged at the axially opposite end sides of the rotor body. The end-side winding portions of all the rotor windings form the winding heads. The rotor can moreover have star disks, wherein in each case one star disk is arranged between a winding head and an end side of the rotor body. The star disks serve inter alia to stabilize the winding heads against rotation-induced centrifugal forces.

The axial winding portions, arranged in the groove, of the adjacent rotor windings are here arranged circumferentially spaced apart from one another, wherein in each case one winding support is arranged between the winding portions. The winding supports have in particular an electrically insulating surface. For example, the winding supports can be made at least partially from a plastic. The winding supports are designed to support or stabilize the rotor windings by each winding support pressing or pushing the associated axial winding portions against the tooth flanks of the associated pole tooth. For this purpose, each winding support has a groove-internal portion which is arranged inside the groove and moreover forms a groove closure for closing the respective groove. The groove-internal portion can have an essentially triangular cross section, wherein in each case one of two sides, extending axially and radially through the groove, of the triangular cross section is arranged adjacent to one of the axial winding portions, and wherein one side, extending axially and tangentially along the pole gap through the groove, of the triangular cross section forms a groove closure for closing the groove. Each winding support moreover has the end portions which axially adjoin the groove-internal portion on both sides, project axially from the grooves, and thus protrude axially at the end sides of the rotor body.

The rotor moreover has the support devices. A support device is here arranged at one of the end sides of the rotor body and thus covers the associated winding head at least partially. The support devices can form cooling bodies for cooling the rotor windings. The support devices have in each case a support ring which is arranged concentrically with the respective winding head, extends from the end side of the rotor body at least over an axial winding head height, and thus radially covers the winding heads. The support rings can take the form of, for example, metal bandages, for example steel bandages. The support devices can moreover have cover elements which are arranged so that they axially overlap the winding heads, wherein the support rings extend axially between the respective end side and the respective cover element. The cover element and the support ring of a support device can be formed as a single part. The cover elements can have, for example, centrally arranged through openings for the rotor shaft of the rotor. The support devices, in particular the cover elements, are fastened on the rotor body by means of an axial force. For example, the axial force for fastening the support devices can be supplied by screws. The support devices can be fixedly screwed to the rotor body directly or indirectly via the star disk.

The winding supports are pushed radially into the grooves with the assistance of the support devices fastened axially to the rotor body and are consequently pressed against the groove-internal winding portions. For this purpose, the winding supports and the support rings form a positive connection. For this, the inner sides, facing the winding heads, of the support rings and the outer sides, bearing against the inner sides of the support rings, of the end portions have in each case slopes running in opposite directions. When the support devices are attached axially to the rotor body, the inner side, sloping in a first direction, of the support ring thus slides over the outer sides, sloping in an opposite second direction, of the end portions arranged distributed circumferentially. A positive or frictional connection in the form of a conical press-fit connection between the annularly arranged winding supports and the support rings is consequently formed axially on both sides. For example, an outer side of the support ring is formed cylindrically and the inner side is formed conically, with the formation of a conical depression. The outer sides of the winding supports are formed with the shape of a cone segment in the end portions arranged, distributed circumferentially, in the respective conical depression. The end portions and the support rings here have the same taper angle. In order to form the slopes running in opposite directions, a radial diameter of the support rings is formed so that it increases, and a radial diameter of the end portions is formed so that it decreases, axially from the respective end side of the rotor body.

By virtue of this conical connection or conical press-fit connection, a radial force directed toward a groove base of the grooves acts on the winding supports and thus presses the latter against the groove-internal winding portions. It is thus advantageously possible to dispense with potting of the rotor with potting compound. The rotor is thus preferably formed without any potting.

It proves to be advantageous if the winding supports in each case have an abutment for the support ring by means of which the winding supports and the support ring are additionally connected axially in form-fitting fashion in the positively connected state. For example, the outer side of the end portions of the winding supports can have a step forming the abutment against which an underside of the respective support ring abuts. The abutment forms the desired end point of the axial movement of pushing the support ring onto the end portions of the winding supports.

The embodiments presented with reference to the rotor according to the invention and their advantages apply correspondingly to the electric machine according to the invention.

Further features of the invention can be found in the claims, the Figures, and the description of the Figures. The features and combinations of features mentioned above in the description, as well as the features and combinations of features mentioned below in the description of the Figures and/or shown individually in the Figures can be used not only in the combination specified in each case but also in other combinations or individually. The invention will now be explained in detail on the basis of a preferred exemplary embodiment and with reference to the drawings, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a first illustration in section of a rotor of an electric machine; and

FIG. 2 shows a second illustration in section of the rotor.

### DETAILED DESCRIPTION OF THE DRAWINGS

The same elements and those with the same function are provided with the same reference signs.

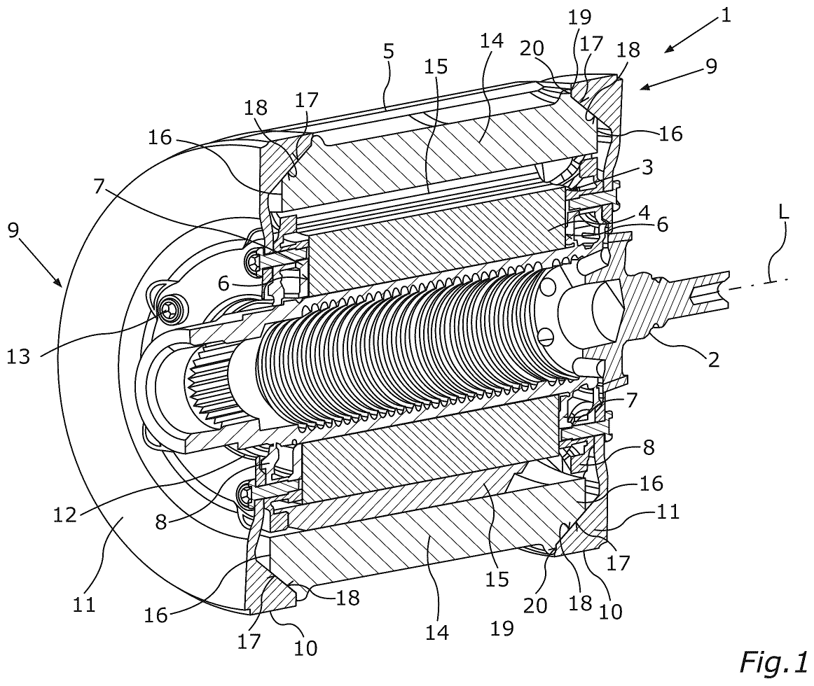

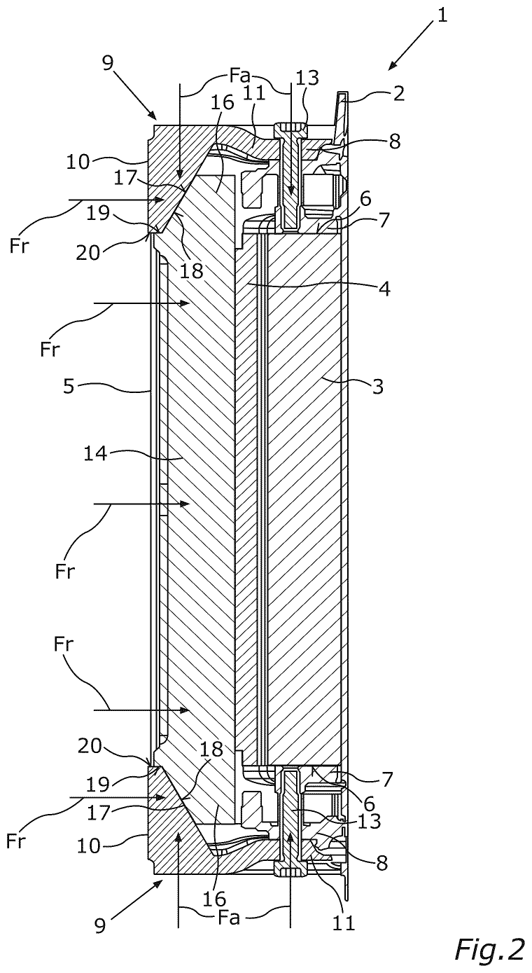

FIG. 1 shows a perspective illustration of a rotor 1, in section along a longitudinal axis L, for an electric machine. FIG. 2 shows half of a longitudinal section of the rotor 1. The longitudinal axis L extends through a rotor shaft 2 of the rotor 1 and corresponds to an axis of rotation of the rotor 1. The rotor 1 has a rotor body 3 which is formed, for example, as a rotor lamination stack. The rotor body 3 has a rotor yoke 4 on which radially protruding salient poles 5 are arranged. Each salient pole 5 carries a rotor winding which cannot be seen here. A star disk 7 which carries in each case a winding head of the rotor windings is here arranged in each case at axially opposite end sides 6 of the rotor body 3. Optional winding head covers 8 which cover the winding heads axially are here arranged so that they axially overlap the star disks 7.

The rotor 1 moreover has two support devices 9 which are arranged so that they axially overlap the end sides 6 of the rotor body 3 and which can form, for example together with the winding head covers 8, cooling devices for the rotor windings. The support devices 9 can be cooled actively, for example with oil. The support devices 9 here have in each case a support ring 10 which radially surrounds the respective winding head, and a cover element 11 which has a passage 12 for the rotor shaft 2 and which is here arranged so that it axially overlaps the respective winding head cover 8. The support ring 10 and the cover element 11 are here formed as a single part by the support ring 10 forming a cylindrical wall and the cover element 11 forming a base region of a pot-shaped support device 9. The support devices 9 are fastened to the rotor body 3 via an axial force Fa. The support devices 9 are here fixed directly on the rotor body 3 via screw connections by screws 13 being passed through the respective cover element 11 and the winding head cover 8 and being screwed into the star disks 7.

The rotor 1 furthermore has winding supports 14 which are arranged in grooves 15 of the rotor body 3 between two salient poles 5. End portions 16 of the winding supports 14 project axially from the grooves 15 and thus protrude at the end sides 6 of the rotor body 3. Axial winding portions of two adjacent rotor windings are additionally arranged in the grooves 15, wherein the winding supports 14 are arranged circumferentially between the axial winding portions and are designed to electrically insulate the axial winding portions with respect to one another and to push them against the respective salient pole 5 in order to stabilize the rotor windings. For this purpose, a radial force Fr acting on the inside of the grooves 15 is applied to the winding supports 14 by means of the support devices 9 by the support devices 9 and the winding supports 14 being connected positively. For this purpose, the end portions 16 and the support rings 10 radially overlapping the end portions 16 have in each case a wedge-shaped cross section. In other words, outer sides 17 of the end portions 16 and inner sides 18 of the support rings 10 arranged concentrically with the winding supports 14 are formed so that they slope in opposite directions such that the outer sides 17 of the end portions 16 bear against the whole surface of the inner side 18 of the respective support ring 10. By virtue of these slopes arranged so that they bear against each other, a positive connection in the form of a conical connection is formed which is designed to transform the axial force Fa supplied by the screw connection into the radial force Fr acting on the winding supports 14. The rotor 1 can thus be formed without any potting. In addition, the outer sides 17 of the end portions 16 have a radially outwardly projecting step 19 which forms an abutment for an underside 20 of the respective support ring 10 and prevents axial slipping of the support ring 10 in the direction of the rotor body 3.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A rotor for an externally excited electric machine of a motor vehicle, comprising:
a rotor body with a plurality of salient poles, wherein in each case one groove extending axially between two end sides of the rotor body is formed between two adjacent salient poles;
rotor windings configured to excite a rotor magnetic field, wherein winding conductors of the rotor windings are wound about the plurality of salient poles with the formation of axial and end-side winding portions, and wherein the axial winding portions of two adjacent rotor windings are arranged in each groove and the end-side winding portions form protruding winding heads at the end sides of the rotor body;
one winding support, per groove, configured to support the rotor windings which is arranged between the axial winding portions of the two adjacent rotor windings and is configured to push the axial winding portions against the associated salient pole;
two support devices, arranged at the end sides of the rotor body and fastened on the rotor body via an axial force, for covering the winding heads;
wherein a support ring, radially surrounding the winding head, of the respective support device has a wedge-shaped cross section, and end portions, projecting axially on both sides from the grooves, of the winding supports have in each case a wedge-shaped cross section which forms, with the wedge-shaped cross section of the respective support ring, a positive conical connection, pushing the winding supports into the grooves via a radial force, between the winding supports and the support devices.

2. The rotor according to claim 1, wherein the rotor is formed without any potting.

3. The rotor according to claim 1, wherein the axial force for fastening the support devices is supplied by screws.

4. The rotor according to claim 1, wherein:
an outer side of the respective support ring is formed cylindrically and an inner side of the support ring is formed conically, with the formation of a conical depression, and an outer side of the winding supports are formed with the shape of a cone segment in the end portions arranged, distributed circumferentially, in the respective conical depression, wherein a radial diameter of the support rings is formed so that it increases, and a radial diameter of the end portions is formed so that it decreases, axially from the respective end side of the rotor body.

5. The rotor according to claim 1, wherein:
the support devices have cover elements which are arranged so that they axially overlap the winding heads, wherein the support rings extend axially between the respective end side and the respective cover element and wherein the cover elements for fastening the support devices are fixed on the rotor body by means of the axial force.

6. The rotor according to claim 1, wherein the support devices form cooling bodies for cooling the rotor windings.

7. The rotor according to claim 1, wherein:
the winding supports have an essentially triangular cross section in a groove-internal portion between the two end portions, wherein in each case one of two sides, extending axially and radially through the groove, of the triangular cross section is arranged adjacent to one of the axial winding portions, and wherein one side, extending axially and tangentially through the groove, of the triangular cross section forms a groove closure for closing the groove.

8. The rotor according to claim 1, wherein:
the winding supports in each case have an abutment for the support ring by means of which the winding supports and the support ring are additionally connected axially in form-fitting fashion in the positively connected state.

9. The rotor according to claim 8, wherein:
an outer side of the end portions of the winding supports has a step forming the abutment against which an underside of the respective support ring abuts.

10. An electric machine with a stator and a rotor according to claim 1, mounted rotatably with respect to the stator.
